(19) United States
(12) Patent Application Publication
(10) Pub. No.: US 2010/0304758 A1
(43) Pub. Date: Dec. 2, 2010

(54) HANDS-FREE DEVICE IN A VEHICLE

(76) Inventor: Henryk Bury, Loehne (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/788,694

(22) Filed: May 27, 2010

(30) Foreign Application Priority Data
May 29, 2009 (DE) 10 2009 023 640.6

(51) Int. Cl. H04W 4/04; H04M 1/00

(52) U.S. Cl. 455/456.1; 455/569.2; 455/558

(57) ABSTRACT

The usefulness of a hands-free device in a vehicle having
a central controller (1, 41), which is fixedly installed in the vehicle and to which a loudspeaker (14) and/or a microphone (11, 51) which are/is installed in the vehicle can be connected,
an intermediate appliance (5; 45, 65), which is arranged on the vehicle within reach of a person transported by the vehicle, and at least one part of which is mechanically fixedly connected to the vehicle and is designed to produce a data and/or speech communication link between a telecommunications appliance and the central controller (1, 41),
   is extended in that a satellite position-finding module is provided in the intermediate appliance (5; 45, 65) and in that the intermediate appliance has a processing stage for association of position data with time details and has a memory device for at least short-term storage of satellite position data with associated time details.

The invention relates to a hands-free device in a vehicle having a central controller, which is fixedly installed in the vehicle and to which a loudspeaker and/or a microphone which are/is installed in the vehicle can be connected, and having an intermediate appliance, which is arranged on the vehicle within reach of a person transported by the vehicle; and at least one part of which is mechanically fixedly connected to the vehicle and is designed to produce a data and/or speech communication link between a telecommunications appliance and the central controller.

Numerous embodiments of hands-free devices such as these are known. One widely used system has a holding panel which is connected by wiring to the central controller which is installed in a concealed position in the vehicle, with the holding panel being installed fixedly in the passenger compartment of the vehicle. A holding shell for a mobile telephone can be snapped onto the holding panel, thus producing an electrical connection at the same time, by means of appropriate contact arrangements, between the central controller and the mobile telephone which has been inserted into the holding shell. In this case, the holding shell is matched to the corresponding mobile telephone in order to ensure that the mobile telephone is held mechanically and to ensure the required electrical contact. The holding shell can be designed such that it essentially passes on the signals arriving at the contacts from the mobile telephone to the central controller, although, in one alternative embodiment, the holding shell may also have its own processing stages, by means of which the specific signals of the mobile telephone used are converted to standard signals. This has the advantage that the central controller need not be matched to different mobile telephones and can therefore remain in the vehicle even when new generations of mobile telephones are intended to be used. For the present invention, the holding panel and the holding shell together form the intermediate appliance, which provides the communication between the mobile telephone and the central controller which is installed in the vehicle.

The invention furthermore relates to known hands-free devices in which the intermediate appliance is a transmitting and receiving appliance and preferably has a display, and therefore it is referred to in the following text as a display appliance. The display appliance can communicate with mobile telephones which have a corresponding transmitting and receiving device for short-range signal transmission, for example to the Bluetooth Standard. In this case, it may be possible to insert the display appliance into a fixedly installed holder, which can be accessed easily by a vehicle occupant in the vehicle, with the holder being linked by wiring to the central controller. Alternatively, it is possible for the display appliance itself to be fixedly installed in the vehicle, and to be linked by wiring to the central controller. In this embodiment, the intermediate appliance is formed by the display appliance on its own or with its holder.

In known hands-free devices, the call can be made via a microphone, which is installed in the vehicle, and via a loudspeaker, which is installed in the vehicle. The connection to the mobile radio network may in this case be made by the mobile telephone itself or by a corresponding mobile telephone transmitting and receiving unit in the hands-free device. In the latter case, it is worthwhile transmitting the access identification data of the mobile telephone to the hands-free unit, which can be done by inserting the SIM card of the mobile telephone, by wire-free transmission (rSAP) of the appropriate data (SIM data) or the like.

For vehicles, in particular for goods vehicles, it is known for an appliance to be provided which contains a receiving and evaluating module for satellite position data (for example GPS) and which transmits satellite position data via the mobile radio network to a control centre, as a result of which the control centre can determine the position of a single goods vehicle. In this case, the data is transmitted to a module which allows any data to be transmitted via the mobile radio network. The appliances provided for this purpose must be additionally installed in a motor vehicle and are therefore relatively costly.

The present invention is based on the object of extending the usefulness of a hands-free device of the type mentioned initially.

According to the invention, in order to achieve this object, a hands-free device of the type mentioned initially is characterized in that a satellite position-finding module is provided in the intermediate appliance and in that the intermediate appliance has a processing stage for association of position data with time details and has a memory device for at least short-term storage of satellite position data with associated time details.

Since the hands-free device according to the invention is provided with a satellite position-finding module and is designed to associate position data with time details and to store mutually associated data pairs, the hands-free device according to the invention can additionally be used in a versatile manner.

For example, it is possible for the hands-free device according to the invention to store the position data with the time details for an entire journey and thus to provide a logbook, which can be read electronically at the end of the journey, for example via a USB plug. Additionally or alternatively, the intermediate appliance of the hands-free device is designed with a transmitting and receiving module for data via a mobile radio network, and the processing stage causes vehicle position data to be transmitted to a control centre at specific time intervals, as a result of which the control centre always has information about the position of the vehicle. In this case, the respectively determined position data need to be stored only for a very short time, in order subsequently to make it possible to transmit it via the mobile radio network to the control centre.

Furthermore, if the intermediate appliance has a communication module, which allows speech transmission, for a mobile radio network and has a read device for subscriber identification data allowing access to the mobile radio network, normal telephone calls can be handled via the hands-free device with the communication module, using an antenna which is fitted to the outside of the vehicle, as a result of which the interior of the vehicle is protected against the radiation load resulting from mobile radio telephony.

The read device of the intermediate appliance may be a card read device for a SIM card. As an alternative to this, the intermediate appliance may be designed for wire-free communication of the subscriber identification data (rSAP) and can thus receive the subscriber identification cards transmitted in a wire-free manner by the telecommunications appliance.

The intermediate appliance may be a holding shell, which is installed on the vehicle, for the telecommunications appliance.

Alternatively, the intermediate appliance may also comprise a display appliance which can be fitted such that it can be connected, preferably detachably, to a holder which is installed fixedly on the vehicle. In this case, it is preferable for the satellite position-finding module and the processing stage to be provided in the display appliance.

In order to allow the hands-free device to be used as an electronic autonomous logbook, the intermediate appliance may have a memory card which is inserted into a card slot and in which satellite position data with associated time details is stored periodically.

In order to make it harder to manipulate the logbook, the intermediate appliance may have a rechargeable battery and a controller by means of which the processing stage remains active for a predetermined time when the display appliance has been removed from its holder. The logbook function can therefore be carried out securely even with a removable display appliance, because the position finding still continues to operate for a certain amount of time, in a silent mode, after the display appliance has been removed from the holder. In this case, the display appliance may have a mechanically operable switch which is arranged such that it is operated during insertion into the holder and during removal from the holder.

In a further preferred embodiment of the invention, the processing stage can be switched between at least two different operating modes. This makes it possible to mark the transmitted data with an identification for a private journey or a business journey, or to interrupt the creation of the data for a private journey, until a new business journey starts.

In one embodiment of the hands-free device, in which the position data is recorded with the associated time details in the form of a logbook, it is worthwhile being able to play back the recorded data to a computer or to some other evaluation or memory device, for example by means of a USB connection.

The risk of manipulation can be further reduced if the accommodation slot for the SIM card or the memory card can be locked after the insertion of the card, and the lock can be removed only by destroying it. The integrity of the intermediate appliance can be checked in this way, and possible manipulative action can be identified immediately.

If regular data transmission is envisaged using the hands-free device according to the invention, the hands-free device may have a network identification for other networks, by means of which the periodic transmission of the data is interrupted in order to avoid incurring high data transmission costs for example when using an expensive network abroad.

An additional use of the embodiment of the intermediate appliance of the hands-free device according to the invention as a display appliance is for the processing stage of the display appliance to be able to use the determined position data to calculate an instantaneous speed, which can be indicated on the display of the display appliance. This allows the display appliance to additionally be used as a warning appliance when a maximum permissible speed, which has been set on the display appliance or is identified by the display appliance, or a desired cruise speed is exceeded.

The embodiment of the intermediate appliance of the hands-free device according to the invention furthermore allows a further secondary use, in that the position data which is processed in the intermediate appliance can be compared with position data stored in the intermediate appliance for danger areas or traffic points which require particular care, and in that the intermediate appliance can emit a warning signal on approaching a danger point such as this. In this case, the nature of the warning signal may possibly differ, depending on the nature of the danger point. For example, in this case, a visual or audible warning of a school or playschool adjacent to the road would be different when the warning of a danger point at which, for example, the maximum permissible speed is subject to permanently installed monitoring. In addition—as explained above—the instantaneous speed can be calculated in the last-mentioned case, and an additional warning can thus be provided if the instantaneous speed exceeds the maximum permissible speed by a predetermined amount.

The invention will be explained in more detail in the following text with reference to exemplary embodiments which are illustrated in the drawing, in which:

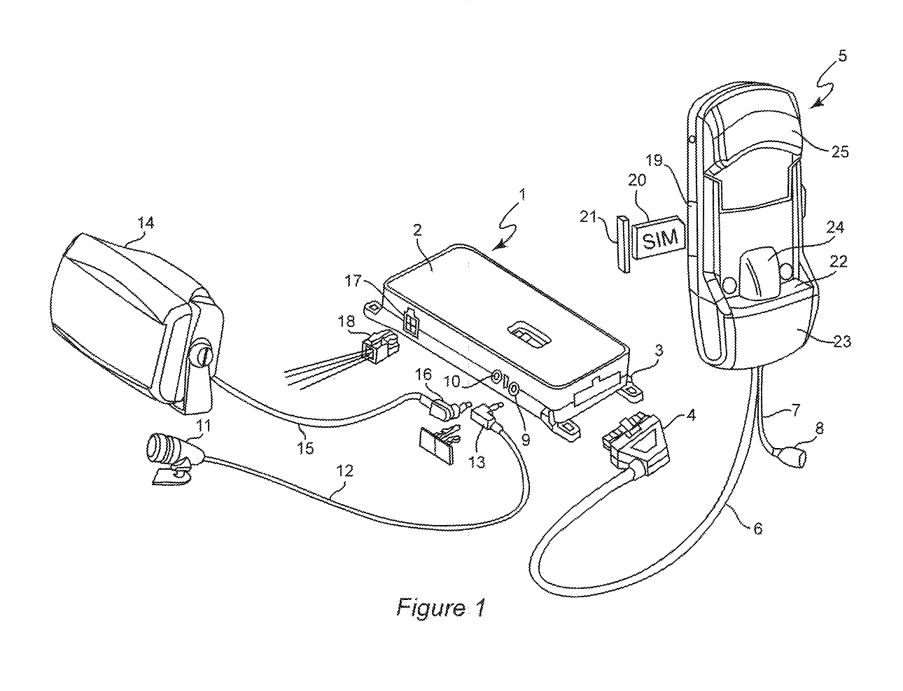

FIG. 1 shows a schematic illustration of a hands-free device according to a first embodiment of the invention, having a holding panel on which a holding shell, which is matched to a telecommunications appliance, can be mounted;

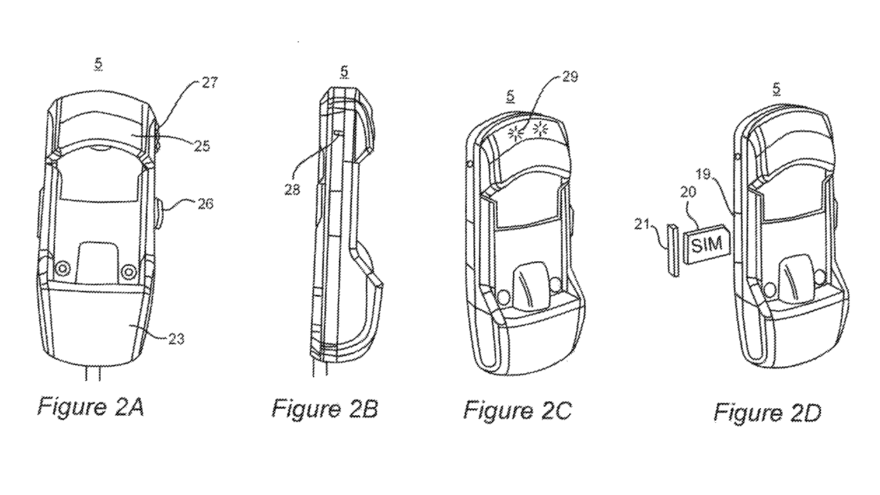

FIG. 2 shows four different views of the holding panel;

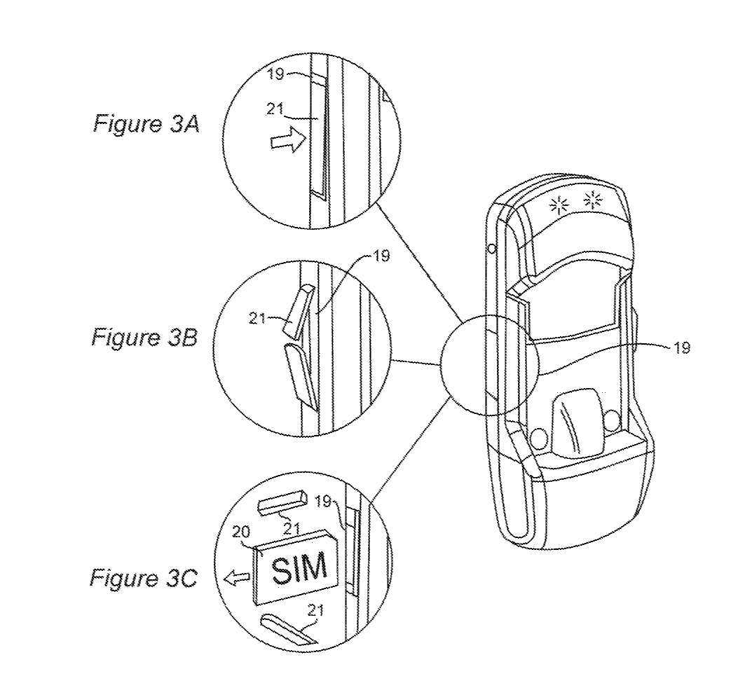

FIG. 3 shows a perspective view of the holding panel with detailed illustrations of a locked card slot, whose cover must be destroyed in order to remove the card;

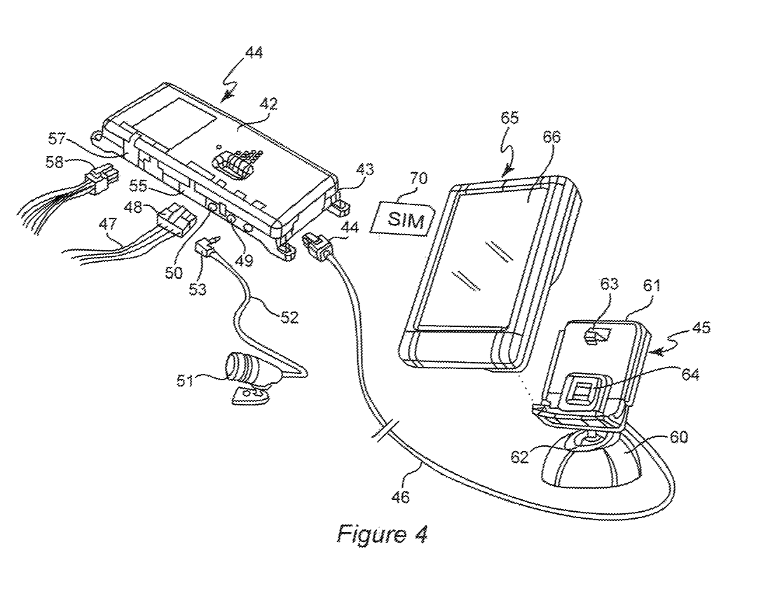

FIG. 4 shows a schematic illustration of a hands-free device with an intermediate appliance which comprises a display appliance with an associated holder;

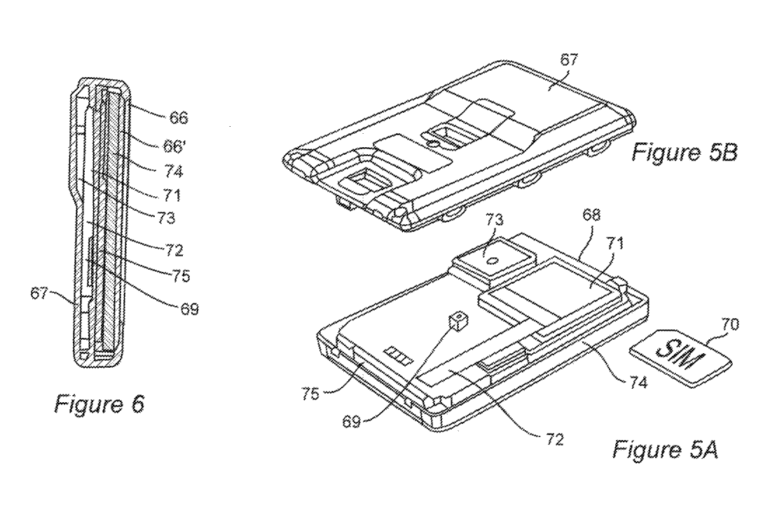

FIG. 5 shows a perspective illustration of the rear face of the display appliance with a rear wall removed;

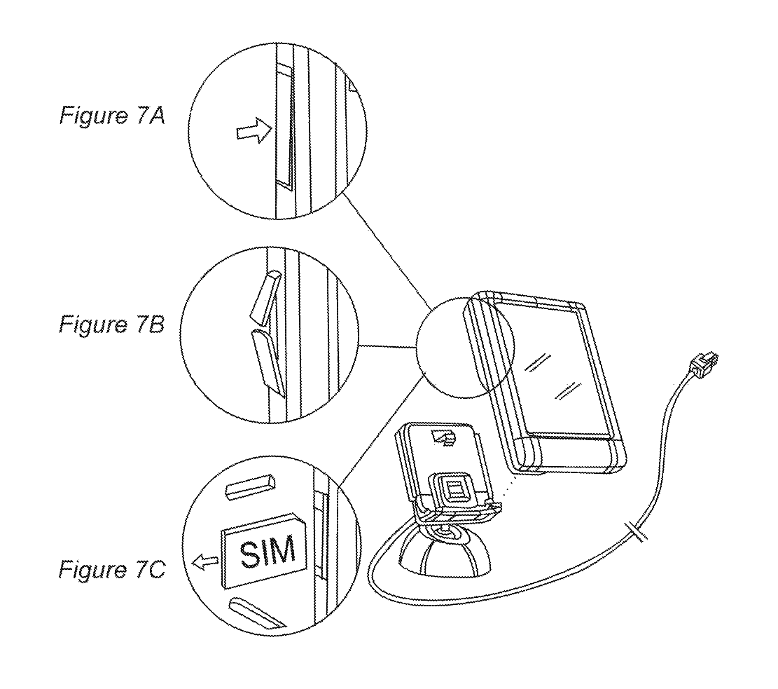

FIG. 6 shows a vertical section through the display appliance shown in FIG. 5; and

FIG. 7 shows a perspective illustration of the display appliance with a holder, with detailed illustrations analogous to FIG. 3.

The hands-free device illustrated schematically in FIG. 1 has a central controller 1 which is installed fixedly in a housing 2 in the vehicle, such that it cannot be seen by passengers in the vehicle, for example in the area behind the dashboard. The central controller 1 is provided with a plug connection 3 for a plug 4 which is located at the end of a cable 6, which is connected to a holding panel 5. A charging cable 7 is passed out of the holding panel 5, in parallel with the cable 6, and can be connected by means of a plug 8 to a supply voltage in the motor vehicle.

Furthermore, the central controller 1 has sockets 9, 10 for the connection of a microphone 11 via a microphone cable 12 by means of a plug 13, which matches the socket 9, and for a loudspeaker 14 via a loudspeaker cable 15, by means of a plug 16 which matches the socket 10. Furthermore, the central controller contains a plug input 17, into which a plug 18 can be inserted in order to allow the central controller 1 to be supplied with a power supply, a signal which identifies that the ignition has been switched on, and a muting signal for a car radio. The signal which characterizes the ignition having been switched on is required in order to activate functions of the hands-free device which are available only when the ignition is switched on. The car radio is muted in order to prevent the reproduction of a radio transmission from interfering with a telephone call via the hands-free device.

As illustrated schematically in FIG. 1, the holding panel 5 has a card slot 19 which is intended for insertion of a SIM card 20, in order to provide subscriber identification data in the holding panel for data transmission via a mobile radio network. The card slot 19 can be locked by a cover 21 which, for example, is latched in the card slot 19 and therefore cannot be removed from the card slot from the outside without destroying it.

The holding panel 5 is provided in a manner known per se with a lower contact chamber 23, which can be locked by a locking panel 22. The locking panel is equipped with an insertion incline 24 such that it can be pivoted for insertion of a corresponding attachment of a holding shell (not illustrated) for the telecommunications appliance, in order to expose contacts in the contact chamber 23. The corresponding insertion of the attachment of the holding shell is possible only when an upper part 25, which is arranged such that it can be moved, is moved upwards against a spring force with the attachment of the holding shell. When the holding shell has been inserted into the holding panel 5, the reset spring of the upper part 25 resets the upper part to the initial position illustrated in the drawing, as a result of which the upper part is latched in a lock (not illustrated) thus ensuring that the holding shell is held securely.

FIG. 2 shows four views of the holding panel 5, specifically a view from the front in FIG. 2a, a side view in FIG. 2b, a perspective oblique plan view with locked card slots 19 in FIG. 2c, and the perspective view as shown in FIG. 2c, illustrating the insertion of the SIM card 20, in FIG. 2d.

The view in FIG. 2a shows an unlocking button 26 at the side, by means of which the lock of the moveable upper part 25 can be released in order to insert the fitting attachment in the holding shell into the holding panel 5, or to remove it therefrom.

A changeover switch 27 is located at the right-hand edge of the holding panel 5 in the area of the upper part 25, by means of which it is possible to switch between a private journey and a business journey, when the holding panel 5 is designed in the manner according to the invention for a logbook function and, for this purpose, is provided with a satellite position-finding module, a processing stage and a memory device, which are all located in the interior of the housing of the holding panel 5, and therefore cannot be seen in the drawing.

A buzzer 28, which confirms the switching by the changeover switch 27, is indicated on the left-hand narrow face of the holding panel 5 in the side view in FIG. 2b. When the satellite position-finding module in the holding shell 5 is used to determine the current speed of travel of the vehicle, the buzzer 28 can also be used to emit a warning signal when a preset maximum speed is exceeded.

FIG. 2c shows the holding panel 5 in the operating state, which can be indicated by two light-emitting diodes 29.

The illustration in FIG. 2d shows the card slot 19, which is still open here, into which the SIM card 20 can be inserted, after which the card slot 19 is locked by the cover 21, which can preferably be snapped in.

The detail illustration a) in FIG. 3 shows the card slot 19 locked by the cover 21. The detail illustration b) shows that the cover 21 must be destroyed in order to open the card slot 19 again and to remove the SIM card 20 (possibly temporarily). Manipulation of the logbook or of the transmitted position data by a removed SIM card 20 can thus be seen on the holding panel.

The second embodiment of a hands-free device according to the invention, which illustrated in FIGS. 4 to 7, has a central controller 41 with a housing 42 whose function corresponds to the function of the central controller 1 with the housing 2 from FIG. 1. A holder is connected via a connecting cable 46 to the central controller 41, via a plug connection 43 via an associated plug 44. The housing 42 of the central controller 41 has sockets 49, 50 which functionally correspond to the sockets 9, 10 in FIG. 1. In consequence, a microphone 51 can be inserted via a microphone cable 52 and a matching plug 53 into the socket 49. Instead of direct connection of a loudspeaker to the socket 50, a multimedia cable 47 with a plug 48 can in this case be inserted into a plug connection 55, via which multimedia cable the telephone call can be reproduced via the loudspeaker which is installed in the vehicle and is connected to a multimedia arrangement via a bus. A plug input 57 corresponds to the plug input 17 of FIG. 1, and is used to hold a plug 58 for supplying, in particular, the muting and ignition state signals.

The holder 45 has an attachment foot 60 by means of which a mounting panel 61 can be adjusted via a ball bearing 62, such that it can be pivoted in three dimensions. The holding panel is provided with a latching arrangement 63 and a contact arrangement 64, via which a display appliance 65 can be mechanically mounted on the holding panel 61, and electrical contact can be made with it. On its front face, the display appliance has a display 66 which is preferably in the form of a touch screen. FIG. 4 shows schematically that, in this embodiment, the display appliance 65 can be provided with a SIM card 70.

FIG. 5 shows the design of the display appliance 65, which has a rear wall 67 which can be removed from a flat housing body 68. An operating element for a switch 69 projects out of the rear wall 67 and is operated during insertion of the display appliance 65 onto the holding panel 61, thus electrically signalling that the display appliance 65 has been inserted.

FIG. 5 furthermore shows a communication module 71 for communication via a mobile radio network with an associated mobile radio antenna 72, which extends as a flat strip along the rear face of the display appliance 65, under the rear wall 67. A satellite antenna 73 for receiving satellite position data is located, together with an associated processing stage, alongside the communication module.

In this case as well, the SIM card 70 can be inserted into a card slot 74 on a narrow side wall of the housing.

FIG. 6 illustrates, in the form of a vertical section, the spatial arrangement of the display 66 with a touch panel 66′, the card slot 74, the communication module 71, the satellite antenna 73 and the mobile radio antenna 72. A flat battery 75 can also be seen, as is known from mobile radios. The switch 69 can be operated through the rear wall 67.

Analogously to FIG. 3, FIG. 7 shows that the SIM card 70 can be inserted into the card slot 74 and can then be locked by a cover 76, in such a way that the SIM card 70 can be removed only by destroying the cover 76.

In both described embodiments of the hands-free device according to the invention, this device is suitable for determining position data and for associating this data with points in time. In this case, the position data can be transmitted at regular intervals via the mobile radio network, since the intermediate appliances, which are formed on the one hand by the holding panel 5 (possibly with a holding shell) or by the holder 45 with the display appliance 65, are provided with a communication module 71 for transmission of data via a mobile radio network.

Alternatively or additionally, both embodiments of the intermediate appliances may for this purpose be provided with a processing stage and a memory device, in order to store the position data, associated with time details, in a memory in the form of a logbook. For this purpose, the intermediate appliances are preferably provided with an interface, via which the stored data can be read to a computer, for example a PC. In one variant, there is no need to transmit the data, as a result of which, rather than the SIM card, a memory card can be used which is removed from the card slot 19, 74 in order to read it, and is inserted into a corresponding card slot in a computer. After the memory card has been inserted again, the card slot 19, 74 is once again locked by a suitable cover 21, 76, in order in this case as well to preclude manipulation, or at least to make it more difficult.

1. Hands-free device in a vehicle, having
a central controller (1, 41), which is fixedly installed in the vehicle and to which a loudspeaker (14) and/or a microphone (11, 51) which are/is installed in the vehicle can be connected,
an intermediate appliance (5; 45, 65), which is arranged on the vehicle within reach of a person transported by the vehicle, and at least one part of which is mechanically fixedly connected to the vehicle and is designed to produce a data and/or speech communication link between a telecommunications appliance and the central controller (1, 41),
characterized in that a satellite position-finding module is provided in the intermediate appliance (5; 45, 65) and in that the intermediate appliance (5; 45, 65) has a processing stage for association of position data with time details and has a memory device for at least short-term storage of satellite position data with associated time details.

2. Hands-free device according to claim 1, characterized by a communication module (71) for a mobile radio network and a transmission device for periodic transmission of the position data via the mobile radio network.

3. Hands-free device according to claim 2, characterized by a read device for subscriber identification data which allows access to the mobile radio network.

4. Hands-free device according to claim 3, characterized in that the read device is a card read device for a SIM card (20, 70).

5. Hands-free device according to claim 1, characterized in that the intermediate appliance is a holding panel (5), which is installed on the vehicle, for holding the telecommunications appliance.

6. Hands-free device according to claim 1, characterized in that the intermediate appliance comprises a holder (45), which is installed fixedly in the vehicle, and a display appliance (65), which can be electrically and mechanically detachably connected to the holder and is designed for wire-free, short-ranging data and speech communication with the telecommunications appliance.

7. Hands-free device according to claim 6, characterized in that the satellite position-finding module and the processing stage are provided in the display appliance (65).

8. Hands-free device according to claim 1, characterized in that the intermediate appliance (5; 45, 65) has a memory card which is inserted into a card slot (19, 74) and in which satellite position data with associated time details is stored periodically.

9. Hands-free device according to claim 6, characterized in that the intermediate appliance (5; 45, 65) has a rechargeable battery (75) and a controller by means of which the processing stage remains active for a predetermined time when the display appliance (65) has been removed from its holder (45).

10. Hands-free device according to claim 9, characterized in that the display appliance (65) has a mechanically operable switch (69) which is arranged such that it is operated during insertion into the holder (45) and during removal from the holder (45).

11. Hands-free device according to claim 1, characterized in that the processing stage can be switched between at least two different operating modes.

12. Hands-free device according to claim 1, having a card slot (19, 74) for a SIM card (20, 70) or a memory card, characterized in that the accommodation slot (19, 74) is designed such that it can be locked after the insertion of the card, and in that the lock can be removed only by destroying it.

13. Hands-free device according to claim 2, characterized in that the communication module (71) compares an identified network with a stored network table and suppresses the periodic transmission of the position data via specific mobile radio networks.

14. Hands-free device according to claim 1, characterized in that the processing stage for the satellite position-finding module is designed to determine a current speed of the vehicle, and in that the determined current speed can be indicated via a display (66).
